(19) United States
(12) Patent Application Publication
(10) Pub. No.: US 2026/0245347 A1
(43) Pub. Date: Aug. 20, 2026

(54) IMAGE SEMANTIC SEGMENTATION MODEL OPTIMIZATION METHOD, ELECTRONIC DEVICE, AND STORAGE MEDIUM

(71) Applicant: Beijing Zitiao Network Technology Co., Ltd., Beijing (CN)

(72) Inventors: Jie QIN, Beijing (CN); Jie WU, Beijing (CN); Yuxi REN, Beijing (CN); Xuefeng XIAO, Beijing (CN)

(21) Appl. No.: 18/876,645

(22) PCT Filed: Jun. 29, 2023
(86) PCT No.: PCT/CN2023/103988

§ 371 Date: Dec. 18, 2024

(30) Foreign Application Priority Data
Jul. 6, 2022 (CN) 202210797439.6

(51) Int. Cl. G06V 10/776; G06V 10/26; G06V 10/774

(52) U.S. Cl. CPC G06V 10/776; G06V 10/26; G06V 10/7753

(57) ABSTRACT

Embodiments of the present disclosure provide an image semantic segmentation model optimization method and apparatus, an electronic device, and a storage medium, and the method includes: acquiring first unlabeled data, and evaluating the first unlabeled data based on a pre-trained target semantic segmentation model to obtain an evaluation value corresponding to the first unlabeled data, in which the evaluation value represents effectiveness of training the target semantic segmentation model with the first unlabeled data; determining target unlabeled data according to the evaluation value corresponding to the first unlabeled data, and generating target labeled data corresponding to the target unlabeled data; and optimizing the target semantic segmentation model based on the target labeled data to obtain an optimized semantic segmentation model.

### CROSS-REFERENCE TO RELATED APPLICATION

The present application claims the priority to Chinese patent application No. 202210797439.6, filed on Jul. 6, 2022, entitled “IMAGE SEMANTIC SEGMENTATION MODEL OPTIMIZATION METHOD AND APPARATUS, ELECTRONIC DEVICE, AND STORAGE MEDIUM,” the entire disclosure of which is incorporated herein by reference as portion of the present application.

### TECHNICAL FIELD

Embodiments of the present disclosure relate to the field of image processing technology, and in particular to an image semantic segmentation model optimization method and apparatus, an electronic device, and a storage medium.

### BACKGROUND

Image semantic segmentation is a technique in which contents in an image are identified such that objects expressing different meanings in the image are separated as different targets. This technique allows for semantic segmentation on an image and possesses basic atomic capability for facilitating human-machine understanding and interaction, and has been widely applied to various kinds of multimedia applications.

For example, an image semantic segmentation model capable of achieving an image semantic segmentation effect may be usually obtained in a manual sample labeling manner in combination with supervised model training.

### SUMMARY

Embodiments of the present disclosure provide an image semantic segmentation model optimization method and apparatus, an electronic device, and a storage medium.

In a first aspect, the embodiments of the present disclosure provide an image semantic segmentation model optimization method, which includes:
acquiring first unlabeled data, and evaluating the first unlabeled data based on a pre-trained target semantic segmentation model to obtain an evaluation value corresponding to the first unlabeled data, in which the evaluation value represents effectiveness of training the target semantic segmentation model with the first unlabeled data; determining target unlabeled data according to the evaluation value corresponding to the first unlabeled data, and generating target labeled data corresponding to the target unlabeled data; and optimizing the target semantic segmentation model based on the target labeled data to obtain an optimized semantic segmentation model.

In a second aspect, the embodiments of the present disclosure provide an image semantic segmentation model optimization apparatus, which includes:
an evaluation module, configured to acquire first unlabeled data, and evaluate the first unlabeled data based on a pre-trained target semantic segmentation model to obtain an evaluation value corresponding to the first unlabeled data, in which the evaluation value represents effectiveness of training the target semantic segmentation model with the first unlabeled data;
a determination module, configured to determine target unlabeled data according to the evaluation value corresponding to the first unlabeled data, and generate target labeled data corresponding to the target unlabeled data; and
an optimization module, configured to optimize the target semantic segmentation model based on the target labeled data to obtain an optimized semantic segmentation model.

In a third aspect, the embodiments of the present disclosure provide an electronic device, which includes a processor and a memory in communication connection with the processor;
the memory stores computer-executable instructions; and
the processor is configured to execute the computer-executable instructions stored in the memory to implement the image semantic segmentation model optimization method according to the first aspect or any embodiment in the first aspect.

In a fourth aspect, the embodiments of the present disclosure provide a computer-readable storage medium, which stores computer-executable instructions, and a processor, when executing the computer-executable instructions, implements the image semantic segmentation model optimization method according to the first aspect or any embodiment in the first aspect.

In a fifth aspect, the embodiments of the present disclosure provide a computer program product including a computer program, and the computer program, when executed by a processor, implements the image semantic segmentation model optimization method according to the first aspect or any embodiment in the first aspect.

In a sixth aspect, the embodiments of the present disclosure provide a computer program, which is configured to implement the image semantic segmentation model optimization method according to the first aspect or any embodiment in the first aspect.

According to the image semantic segmentation model optimization method and apparatus, the electronic device, and the storage medium provided by the embodiments of the present disclosure, the first unlabeled data is acquired, and the first unlabeled data is evaluated based on the pre-trained target semantic segmentation model to obtain the evaluation value corresponding to the first unlabeled data, in which the evaluation value represents the effectiveness of training the target semantic segmentation model with the first unlabeled data; the target unlabeled data is determined according to the evaluation value corresponding to the first unlabeled data, and the target labeled data corresponding to the target unlabeled data is generated; and the target semantic segmentation model is optimized based on the target labeled data to obtain the optimized semantic segmentation model. Before training the target semantic segmentation model, the unlabeled data is firstly screened using the evaluation value corresponding to the unlabeled data to obtain the labeled data which is more effective for the training effect, and therefore, the target semantic segmentation model is trained based on the target labeled data.

### BRIEF DESCRIPTION OF DRAWINGS

In order to more clearly illustrate the technical solutions of the embodiments of the present disclosure, the drawings that need to be used in description of the embodiments will be briefly described in the following. Apparently, the drawings in the following description are only some embodiments of the present disclosure. For those skilled in the art, other drawings can also be obtained based on these drawings without any inventive work.

FIG. 1 is a schematic diagram of an application scenario of an image semantic segmentation model optimization method provided by the embodiments of the present disclosure;

FIG. 2 is a first schematic flowchart of an image semantic segmentation model optimization method provided by the embodiments of the present disclosure;

FIG. 3 is a schematic diagram of a process of generating target labeled data provided by the embodiments of the present disclosure;

FIG. 4 is a schematic flowchart of implementation steps of step S103 in the embodiment shown in FIG. 2;

FIG. 5 is a second schematic flowchart of an image semantic segmentation model optimization method provided by the embodiments of the present disclosure;

FIG. 6 is a schematic diagram of a process of data evaluation based on a target semantic segmentation model provided by the embodiments of the present disclosure;

FIG. 7 is a schematic flowchart of implementation steps of step S204 in the embodiment shown in FIG. 5;

FIG. 8 is a schematic diagram of a process of generating a supervised loss and an unsupervised loss based on a target semantic segmentation model provided by the embodiments of the present disclosure;

FIG. 9 is a schematic flowchart of implementation steps of step S210 in the embodiment shown in FIG. 5;

FIG. 10 is a structural block diagram of an image semantic segmentation model optimization apparatus provided by the embodiments of the present disclosure;

FIG. 11 is a schematic structural diagram of an electronic device provided by the embodiments of the present disclosure; and

FIG. 12 is a schematic diagram of a hardware structure of an electronic device provided by the embodiments of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the disclosure.

An application scenario of the embodiments of the present disclosure is explained below.

FIG. 1 is a schematic diagram of an application scenario of an image semantic segmentation model optimization method provided by the embodiments of the present disclosure. The image semantic segmentation model optimization method provided by the embodiments of the present disclosure may be applied to an application scenario of model training before the deployment of the image semantic segmentation model. Specifically, the method provided by the embodiments of the present disclosure may be applied to devices for model training such as a terminal device and a server. The server is taken as an example in FIG. 1. As shown in FIG. 1, exemplarily, unlabeled data and an initialized image semantic segmentation model are prestored in the server. The server firstly receives a labeling instruction sent by a terminal device to label the unlabeled data as labeled data, and then receives a training instruction sent by the terminal device to train the image semantic segmentation model to obtain an optimized model. This process may be performed repeatedly for a plurality of times until a model convergence condition is met, thereby obtaining an image semantic segmentation model capable of achieving the image semantic segmentation effect. Subsequently, the image semantic segmentation model may be deployed to the server, and provide an image semantic segmentation service in response to a request of other terminal devices or servers.

In the related art, training the image semantic segmentation model is mainly achieved based on the manual sample labeling manner in combination with supervised training or semi-supervised training of the model. In this process, the user needs to manually label at least part of samples with a labeling instruction. However, such an expert-oriented, expensive and time-consuming labeling process limits the amount of labeled samples generated. Therefore, during the process of training the image semantic segmentation model, the problem of insufficient labeled training samples may often arise, thereby affecting the model training effect. In the related art, unlabeled data with pseudo-labels may be generated by semi-supervised training to enhance the model training effect. However, because the generated unlabeled data has certain randomness, the problem of nonuniform distribution of data sample categories may easily occur, leading to problems such as a large performance fluctuation range and poor performance stability of the trained model and affecting the application performance of the model. Due to high cost and low efficiency of manual sample labeling, the image semantic segmentation model may be trained insufficiently and the performance of the model may be affected. The embodiments of the present disclosure provide an image semantic segmentation model optimization method to solve the problems described above.

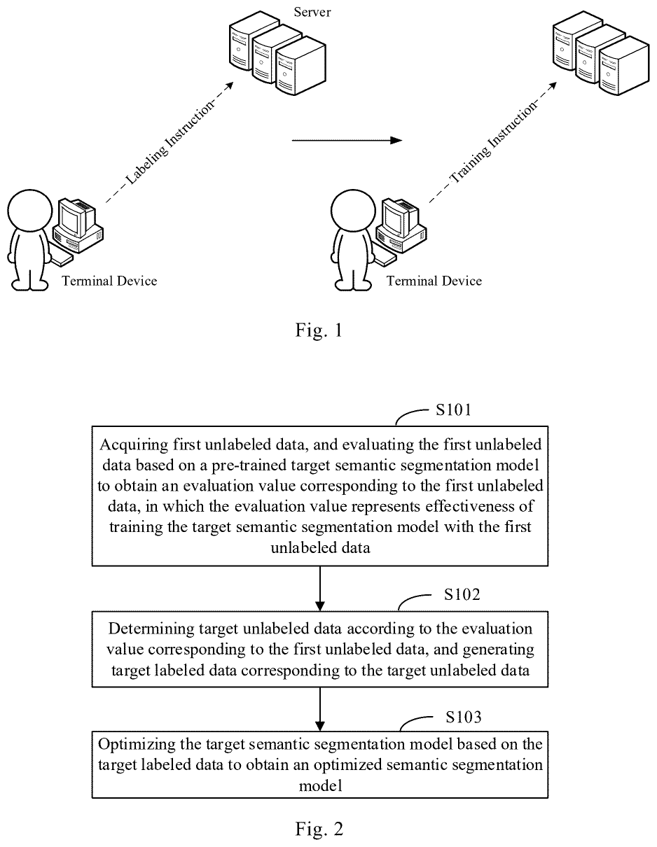

With reference to FIG. 2, FIG. 2 is a first schematic flowchart of an image semantic segmentation model optimization method provided by the embodiments of the present disclosure. The method of the present embodiment may be applied to an electronic device having a computing capability. Taking a terminal device as an example, the image semantic segmentation model optimization method includes the following steps.
Step S101: acquiring first unlabeled data, and evaluating the first unlabeled data based on a pre-trained target semantic segmentation model to obtain an evaluation value corresponding to the first unlabeled data, in which the evaluation value represents effectiveness of training the target semantic segmentation model with the first unlabeled data.

Exemplarily, the unlabeled data refers to image data with no label information, e.g., a photo containing contents such as a person and a landscape. The unlabeled data may be an original image captured by a camera, or may be an image after being processed by an image processing technique such as a filter and a special effect, which is not limited here. The unlabeled data may be easily acquired by way of Internet and the like, and thus has the advantages of low acquisition difficulty, rich acquired image contents, and the like.

Further, exemplarily, the first unlabeled data is prestored in a server and is image data for the target semantic segmentation model. The target semantic segmentation model is a semantic segmentation model that has been trained for at least one round. The target semantic segmentation model is configured to process the first unlabeled data input thereto and output a corresponding segmentation result image. After different first unlabeled data is input, due to the difference of the first unlabeled data, the model will predict different segmentation results after the data is processed by the model. For example, after the first unlabeled data data_1 is input to the target semantic segmentation model, a segmentation result result_1 is output, which is similar to or the same as a real segmentation result; while after the first unlabeled data data_2 is input to the target semantic segmentation model, a segmentation result result_2 is output, which greatly differs from the real segmentation result. During a later process of continuing to optimize the target semantic segmentation model, because data_2 is not correctly predicted by the correct model (i.e., the model cannot segment such type of image data), training the model using data_2 is more effective. Thus, the corresponding first unlabeled data may be evaluated according to the output result of the target semantic segmentation model, thereby obtaining one evaluation value. Exemplarily, in response to the evaluation value being higher, it indicates that training the target semantic segmentation model using the input first unlabeled data is more effective, and the first unlabeled data is more suitable for training the model. Conversely, in response to the evaluation value being lower, it indicates that training the target semantic segmentation model using the input first unlabeled data is less effective, and the first unlabeled data is less suitable for training the model.
Step S102: determining target unlabeled data according to the evaluation value corresponding to the first unlabeled data, and generating target labeled data corresponding to the target unlabeled data.

Exemplarily, subsequently, after the evaluation value of the first unlabeled data is obtained, based on the magnitude of the evaluation value, at least one piece of first unlabeled data is determined, i.e., the target unlabeled data. Specifically, in an optional implementation, pieces of first unlabeled data are ranked according to their evaluation values, and M top-ranked pieces of first unlabeled data are determined as the target unlabeled data, where M is an integer greater than 1. In another optional implementation, the pieces of first unlabeled data are screened according to a preset evaluation threshold, and the first unlabeled data having the evaluation value greater than the evaluation threshold is determined as target unlabeled data. In yet another optional implementation, the evaluation values of the pieces of first unlabeled data may also be ranked in combination with the above-mentioned two methods, and the pieces of first unlabeled with M top-ranked evaluation values greater than the evaluation threshold are determined as the target unlabeled data. The above-mentioned several manners may be set as required, which are not specifically defined here.

Exemplarily, the target unlabeled data is processed afterwards to generate the corresponding target labeled data. This process is a process of labeling the target unlabeled data. Image segmentation is performed based on the image content of the target unlabeled data to generate segmentation result images for indicating information such as a position and a category of an object in the image. In an optional implementation, after the target unlabeled data is determined, an image content identifier corresponding to the target unlabeled data is identified by a pre-trained image identification model, and an image segmenter corresponding to the image content identifier is called to perform image segmentation on the target unlabeled data to obtain labeling information corresponding to the target unlabeled data. The labeling information is then combined into the target labeled data corresponding to the target unlabeled data.

In another optional implementation, after the target unlabeled data is determined, the terminal device segments the target unlabeled data according to a labeling instruction input by the user, thereby generating labeling information corresponding to the target unlabeled data. The labeling information is then combined into the target labeled data corresponding to the target unlabeled data. The above-mentioned two manners of generating the target labeled data may be set as required, which are not specifically defined here.

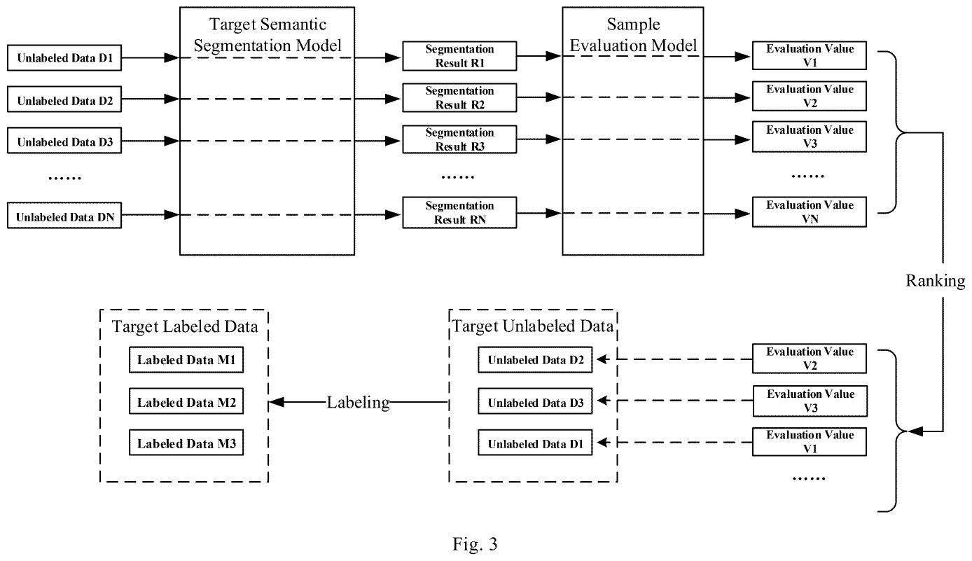

FIG. 3 is a schematic diagram of a process of generating target labeled data provided by the embodiments of the present disclosure. The process of generating the target labeled data is further described below with reference to FIG. 3. As shown in FIG. 3, after N sets of unlabeled data (shown in the figure as unlabeled data D1 to unlabeled data DN) are separately input to the target semantic segmentation model, the target semantic segmentation model outputs segmentation result images (shown in the figure as segmentation result R1 to segmentation result RN) corresponding to the unlabeled data. The segmentation results are then evaluated using a preset sample evaluation model to obtain evaluation values (shown in the figure as evaluation value V1 to evaluation value VN) corresponding to evaluation results. The evaluation values V1 to VN are ranked, in which the first three (exemplarily) evaluation values are V2, V3, and V1, respectively. Unlabeled data D2, unlabeled data D3, and unlabeled data D1 corresponding to V2, V3, and V1 are then determined as the target unlabeled data respectively. Subsequently, the target unlabeled data is labeled to obtain corresponding target labeled data (shown in the figure as labeled data M1, labeled data M2, and labeled data M3) for training the target semantic segmentation model.

In the present embodiment, before the target semantic segmentation model is trained, the unlabeled data is evaluated firstly using current parameters of the model, and the unlabeled data having a good training effect is labeled according to an evaluation result, thereby generating the target labeled data having the good training effect. Compared with the solution of randomly labeling unlabeled data to obtain labeled data, the target labeled data having a better training effect may be obtained, and the model is then trained with the target labeled data such that the model convergence speed may be increased and the amount of the labeled data required may be reduced.
Step S103: optimizing the target semantic segmentation model based on the target labeled data to obtain an optimized semantic segmentation model.

Exemplarily, after the target labeled data is obtained, the target semantic segmentation model is trained based on the target labeled data so that the image segmentation capability of the target semantic segmentation model may be improved and the optimized semantic segmentation model may be obtained. In an optional implementation, fully supervised training may be performed on the target semantic segmentation model based on the target labeled data. That is, the target semantic segmentation model is trained by only using the target labeled data obtained in the above-mentioned steps, and model parameters are adjusted based on an obtained supervised loss so that a high-quality optimized semantic segmentation model may be obtained.

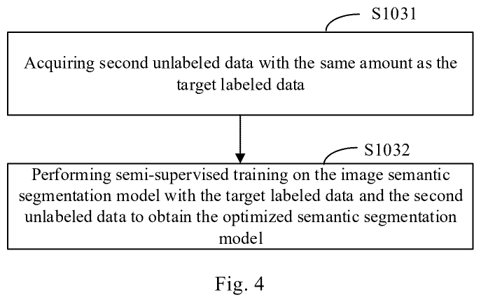

In another optional implementation, the target semantic segmentation model may be trained in a semi-supervised manner based on the target labeled data in combination with the unlabeled data. Thus, the training of the target semantic segmentation model is realized on the basis of a small amount of target labeled data, and the model training effect is enhanced. Exemplarily, as shown in FIG. 4, step S103 includes the following implementation steps:
Step S1031: acquiring second unlabeled data with the same amount as the target labeled data; and
Step S1032: performing semi-supervised training on the image semantic segmentation model with the target labeled data and the second unlabeled data to obtain the optimized semantic segmentation model.

Exemplarily, semi-supervised training is an approach of training a model using unlabeled data as a supplement to the labeled data. In the present embodiment, a corresponding amount of pieces of second unlabeled data are acquired and pseudo-labels are generated for the second unlabeled data such that the target labeled data and the second unlabeled data are involved in the model training process. The pseudo-labels of the second unlabeled data may be acquired by model prediction. The process of performing semi-supervised training on the model with the labeled data and the unlabeled data is not described redundantly here.

In the present embodiment, the first unlabeled data is acquired, and the first unlabeled data is evaluated based on the pre-trained target semantic segmentation model to obtain the evaluation value corresponding to the first unlabeled data, in which the evaluation value represents the effectiveness of training the target semantic segmentation model with the first unlabeled data; the target unlabeled data is determined according to the evaluation value corresponding to the first unlabeled data, and the target labeled data corresponding to the target unlabeled data is generated; and the target semantic segmentation model is optimized based on the target labeled data to obtain the optimized semantic segmentation model. Before training the target semantic segmentation model, the unlabeled data is firstly screened using the evaluation value corresponding to the unlabeled data to obtain the labeled data which is more effective for the training effect, and therefore, the target semantic segmentation model is trained based on the target labeled data. The model training effect may be improved and the amount of training samples required may be reduced. Thus, a convergent model may be obtained more rapidly and the model performance may be improved.

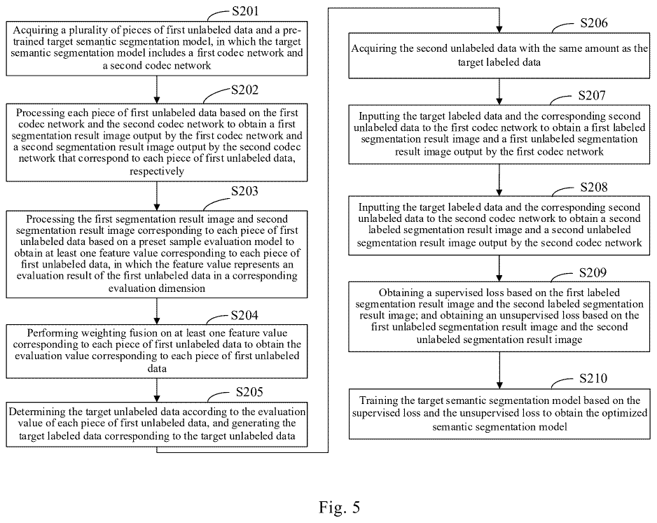

With reference to FIG. 5, FIG. 5 a second schematic flowchart of an image semantic segmentation model optimization method provided by the embodiments of the present disclosure. The present embodiment provides further details of steps S101 and S103 on the basis of the embodiment shown in FIG. 2. The image semantic segmentation model optimization method includes the following steps.
Step S201: acquiring a plurality of pieces of first unlabeled data and a pre-trained target semantic segmentation model, in which the target semantic segmentation model includes a first codec network and a second codec network.
Step S202: processing each piece of first unlabeled data based on the first codec network and the second codec network to obtain a first segmentation result image output by the first codec network and a second segmentation result image output by the second codec network that correspond to each piece of first unlabeled data, respectively.
Step S203: processing the first segmentation result image and second segmentation result image corresponding to each piece of first unlabeled data based on a preset sample evaluation model to obtain at least one feature value corresponding to each piece of first unlabeled data, in which the feature value represents an evaluation result of the first unlabeled data in a corresponding evaluation dimension.

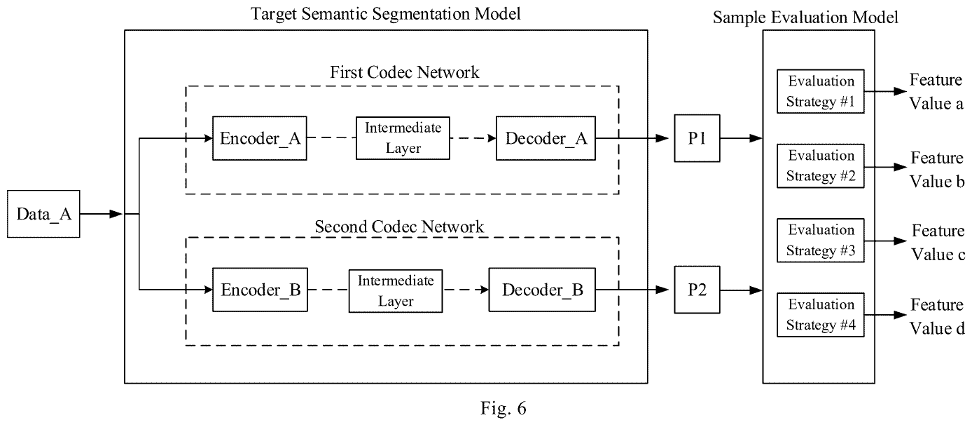

Exemplarily, FIG. 6 is a schematic diagram of a process of data evaluation based on a target semantic segmentation model provided by the embodiments of the present disclosure. As shown in FIG. 6, the target semantic segmentation model includes a first codec network and a second codec network. The codec network is a network structure including an encoder and a decoder, and is configured to segment image data and output segmentation result images of the image data. Optionally, one or more intermediate layers for feature extraction are further provided between the encoder and the decoder. The first codec network and the second codec network both have the above-mentioned codec network structure, but the first codec network and the second codec network correspond to different network parameters. Exemplarily, as shown in the figure, the first codec network includes Encoder Encoder_A and decoder Decoder_A, and the second codec network includes Encoder Encoder_B and decoder Decoder_B. Therefore, when the same image data is processed, different image segmentation results would be output.

Further, after the first unlabeled data Data_A (shown in the figure as Data_A) is separately input to the first codec network and the second codec network, the first codec network and the second codec network process the first unlabeled data based on respective network parameters, and output corresponding first segmentation result image P1 (shown in the figure as P1) and second segmentation result image P2 (shown in the figure as P2), respectively. The first segmentation result image P1 and the second segmentation result image P2 are then input to a preset sample evaluation model for processing. The first segmentation result image P1 and the second segmentation result image P2 are used as an overall input value to the sample evaluation model and evaluated according to evaluation strategies (shown in the figure as evaluation strategy #1, evaluation strategy #2, evaluation strategy #3, and evaluation strategy #4) in the sample evaluation model to obtain corresponding feature values. Exemplarily, as shown in the figure, the sample evaluation model outputs four feature values: feature value a, feature value b, feature value c, and feature value d. The feature value a, the feature value b, the feature value c, and the feature value d represent evaluation results of the first unlabeled data Data_A in one evaluation dimension, respectively. Subsequently, after determination according to one or more feature values, in response to a determination condition is met, Data_A may be determined as the target unlabeled data. Data_A is then labeled to generate the target labeled data (this process is not shown in the figure).

Exemplarily, the feature value includes at least one selected from a group consisting of an information entropy evaluation value, a difficulty evaluation value, a diversity evaluation value, and a consistency evaluation value.

The information entropy evaluation value is configured to represent the amount of information in the first unlabeled data; the difficulty evaluation value is configured to represent a predicted difficulty of the target semantic segmentation model for the first unlabeled data; the diversity evaluation value is configured to represent a predicted difference between the first segmentation result image and the second segmentation result image; and the consistency evaluation value is configured to represent a divergence distance between the first segmentation result image and the second segmentation result image. With reference to FIG. 6, for example, the feature value a is the information entropy evaluation value, the feature value b is the difficulty evaluation value, the feature value c is the diversity evaluation value, and the feature value d is the consistency evaluation value. By the above-mentioned implementation of the feature values, the first unlabeled data can be evaluated in a plurality of evaluation dimensions, thereby accurately determining the effectiveness of training the target semantic segmentation model with the first unlabeled data, improving the quality of the labeled data generated in the subsequent step, and improving the model training effect.

The above-mentioned feature values are described in detail below.

The information entropy evaluation value is a segmentation-oriented information entropy evaluation indicator based on a significant region, and thus may also be referred to as a region-level information entropy. The information entropy evaluation value is an entropy of a region-level probability distribution predicted based on two branches (the first codec network and the second codec network) to measure the amount of information of an unlabeled sample (the first unlabeled data). A higher information entropy evaluation value indicates a greater prediction uncertainty of the target semantic segmentation model, which indicates a larger amount of information of the first unlabeled data. Therefore, a better training effect may be achieved, and it should be determined that a subsequent labeling step is performed on the target unlabeled data (to generate the target labeled data). To adapt to the property of segmentation that takes pixels as emphasis, the information entropy evaluation value focuses more on a foreground concept and covers part of a background region. In the present embodiment, a segmentation core region has a predicted pixel value higher than a threshold r. Therefore, a region mask M_{c} corresponding to category c is as shown in the following formula (1):

$${M}_{c} = \{ \begin{matrix}0 , {y}_{c} < τ \\ 1 , {y}_{c} \geq τ\end{matrix} . \qquad ( 1 )$$

y_{c} represents a predicted value of the category c in a segmentation result image, and τ represents the threshold. Thus, the information entropy evaluation value is as shown in the following formula (2):

$${S}_{RI}^{k} = - {\sum }_{c = 1}^{N} \frac{{\sum }_{i = 1}^{H \times W} ( {m}_{ci} {y}_{ci} log ( {y}_{ci} ) )}{{\sum }_{i = 1}^{H \times W} ( {m}_{ci} )} . \qquad ( 2 )$$

m_{ci} represents a value of a generated mask M_{c}; y_{ci} represents a predicted value of the output Y; H×W represents a size of the segmentation result image; N represents the amount of semantic categories; and

$${S}_{RI}^{k}$$

represents an information entropy of the k-th branch (which is the first codec network when k=1, and the second codec network when k=2). Finally, the calculation process of a weighted score S_{RI} is as shown in the following formula (3):

$${S}_{RI} = \frac{1}{K} {\sum }_{k = 1}^{K} {S}_{RI}^{k} . \qquad ( 3 )$$

K represents the amount of branches. The obtained region-level information score S_{RI} represents an extent of the amount of information included in each unlabeled sample (the first unlabeled data). A sample with a higher score S_{RI} means it containing richer information, which is more valuable for subsequent labeling.

The difficulty evaluation value is an indicator that introduces a region-level difficulty strategy to select unlabeled data difficult to predict in order to measure the difficulty of a segmentation-oriented task. This strategy firstly follows a region-level information entropy strategy to obtain the region mask M_{c} corresponding to each category. A joint mask M_{U} for all categories is then generated, and this calculation process is as shown in the following formula (4):

$${M}_{U} = {⋃}_{c = 1}^{N} {M}_{c} . \qquad ( 4 )$$

M_{c} represents the region mask of the category c; N represents the amount of semantic categories; and ∪ represents per pixel or operation.

The calculation process of a region level number

$${S}_{RD}^{k}$$

is as shown in the following formula (5):

$${S}_{RD}^{k} = - \frac{{\sum }_{i = 1}^{H \times W} {m}_{i}^{U} ( conf ( {y}_{i} ) )}{{\sum }_{i = 1}^{H \times W} ( {m}_{i}^{U} )} . \qquad ( 5 )$$

$${m}_{i}^{U}$$

represents a value of the joint mask; conf(yᵢ) represents a confidence value of a segmentation result image having a maximization operation; and

$${S}_{RD}^{k}$$

represents a score obtained for the k-th branch. Finally, the calculation process of a region-level difficulty score, i.e., the difficulty evaluation value S_{RD}, is as shown in the following formula (6):

$${S}_{RD} = \frac{1}{K} {\sum }_{k = 1}^{K} {S}_{RD}^{k} . \qquad ( 6 )$$

K represents the amount of branches, and S_{RD} represents the difficulty of the current target semantic segmentation model in predicting the first unlabeled data.

The diversity evaluation value, i.e., a patch-level diversity, is configured to represent a local correlation between prediction results of two branches (the first codec network and the second codec network). A greater diversity evaluation value indicates that the two branches tend to generate different predictions for the same input, which indicates that labeling these samples is valuable.

Firstly, the output predicted segmentation result image Y∈R^{N×H×W} is split into patches and encoded as a patch-level representation Yₚ∈R^{N×H}^{ₚ}^{×W}^{ₚ}. Each pixel in Yₚ represents a predicted patch-level local content. A cosine similarity between the patches is then calculated using the unfolded patch-level representation Yₚ∈R^{N×H}^{ₚ}^{W}^{ₚ}, and an autocorrelation matrix

$$Φ ( {Y}_{p}^{T} , {Y}_{p} ) ∈ {R}^{{H}_{p} {W}_{p} \times {H}_{p} {W}_{p}}$$

is generated, and this calculation process is as shown in the following formula (7):

$${ϕ}_{ij} = \frac{{y}_{pi}^{T} {y}_{pj}}{‖ {y}_{pi} ‖ ‖ {y}_{pj} ‖} . \qquad ( 7 )$$

φᵢⱼ represents a correlation between vectors yₚᵢ and yₚⱼ, where yₚᵢ and yₚⱼ are patch vectors of Yₚ. The autocorrelation matrix reflects a local context relationship of the prediction results. In addition, a cross correlation matrix

$$Ψ ( {Y}_{p 1}^{T} , {Y}_{p 2} ) ∈ {R}^{{H}_{p} {W}_{p} \times {H}_{p} {W}_{p}}$$

is also obtained in the same calculation manner with the autocorrelation matrix. The autocorrelation matrix and the cross correlation matrix are then weighted to calculate a patch-level diversity score, i.e., the diversity evaluation value S_{PD}, and this calculation process is as shown in the following formula (8):

$${S}_{PD} = \frac{1}{{H}_{p} {W}_{p} \times {H}_{p} {W}_{p}} {\sum }_{i = 1}^{{H}_{p} {W}_{p} \times {H}_{p} {W}_{p}} ( \vert {ϕ}_{1} - {ϕ}_{2} \vert - αψ ) . \qquad ( 8 )$$

φ₁ and φ₂ represent values of the autocorrelation matrix, respectively; ψ represents a value of the cross correlation matrix; HₚWₚ×HₚWₚ represents the size of a correlation matrix; and a represents a coefficient for balancing autocorrelation and cross correlation matrices. Greater S_{PD} means a significant difference between predictions of two branches for the same sample, indicating that the current samples are difficult to distinguish and labeling this type of samples (the first unlabeled data) is more valuable.

The consistency evaluation value is an evaluation value that introduces a global-level consistency score to calculate a global KL divergence distance between two predictions in order to measure a relationship between distributions of prediction results of two branches (the first codec network and the second codec network) in a global dimension. The calculation process of the consistency evaluation value S_{GC} is as shown in the following formula (9):

$${S}_{GC} = \frac{1}{N \times H \times W} {\sum }_{i = 1}^{N \times H \times W} ( {y}_{1 i} log ( \frac{{y}_{1 i}}{{y}_{2 i}} ) ) . \qquad ( 9 )$$

y₁ᵢ and y₂ᵢ represent pixel values of the prediction results of the two branches (the first codec network and the second codec network), and N×H×W represents the size of an output result. A greater score S_{GC} means the current sample (the first unlabeled data) being difficult to predict and needing to be labeled for training.
Step S204: performing weighting fusion on at least one feature value corresponding to each piece of first unlabeled data to obtain the evaluation value corresponding to each piece of first unlabeled data.

Exemplarily, after the above-mentioned at least one feature value is acquired, weighting fusion is performed on respective feature values to obtain the evaluation value corresponding to each piece of first unlabeled data. A greater score of the evaluation value represents that the first unlabeled data is more effective and further needs to be determined as the target unlabeled data for subsequent labeling.

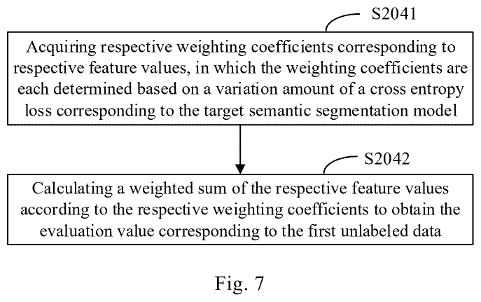

In an optional implementation, as shown in FIG. 7, step S204 includes the following implementation steps:
step S2041: acquiring respective weighting coefficients corresponding to respective feature values, in which the weighting coefficients are each determined based on a variation amount of a cross entropy loss corresponding to the target semantic segmentation model; and
step S2042: calculating a weighted sum of the respective feature values according to the respective weighting coefficients to obtain the evaluation value corresponding to the first unlabeled data.

Exemplarily, in response to weighting fusion is performed on respective feature values, the weighting coefficients corresponding to respective feature values may be determined based on experience, or may be determined using the method in the step of this embodiment, based on the variation amount of the cross entropy loss corresponding to the target semantic segmentation model. For example, the evaluation value corresponding to the first unlabeled data is as shown in the following formula (10):

$${S}_{All} = {S}_{RI} + {λ}_{1} {S}_{RD} + {λ}_{2} {S}_{PD} + {λ}_{3} {S}_{GC} \qquad ( 10 )$$

S_{All} represents the evaluation value after weighting calculation; S_{RI} represents the information entropy evaluation value; S_{RD} represents the difficulty evaluation value; λ₁ represents the weighting coefficient of S_{RD}; S_{PD} represents the diversity evaluation value; λ₂ represents the weighting coefficient of S_{PD}; S_{GC} represents the consistency evaluation value; and λ₃ represents the weighting coefficient of S_{GC}. Ranking is made according to the evaluation value S_{All} to determine the target unlabeled data. After the target labeled data is generated by labeling, the target semantic segmentation model is trained with the target labeled data to obtain the corresponding cross entropy loss. According to the magnitude of the cross entropy loss, λ₁, λ₂, and λ₃ are adjusted within a certain range such that the weighting coefficient is regulated to reduce the cross entropy loss. Thus, the value of the weighting coefficient is optimized and the evaluation accuracy of the evaluation value is improved.
Step S205: determining the target unlabeled data according to the evaluation value of each piece of first unlabeled data, and generating the target labeled data corresponding to the target unlabeled data.
Step S206: acquiring the second unlabeled data with the same amount as the target labeled data.
Step S207: inputting the target labeled data and the corresponding second unlabeled data to the first codec network to obtain a first labeled segmentation result image and a first unlabeled segmentation result image output by the first codec network.
Step S208: inputting the target labeled data and the corresponding second unlabeled data to the second codec network to obtain a second labeled segmentation result image and a second unlabeled segmentation result image output by the second codec network.
Step S209: obtaining a supervised loss based on the first labeled segmentation result image and the second labeled segmentation result image; and obtaining an unsupervised loss based on the first unlabeled segmentation result image and the second unlabeled segmentation result image.

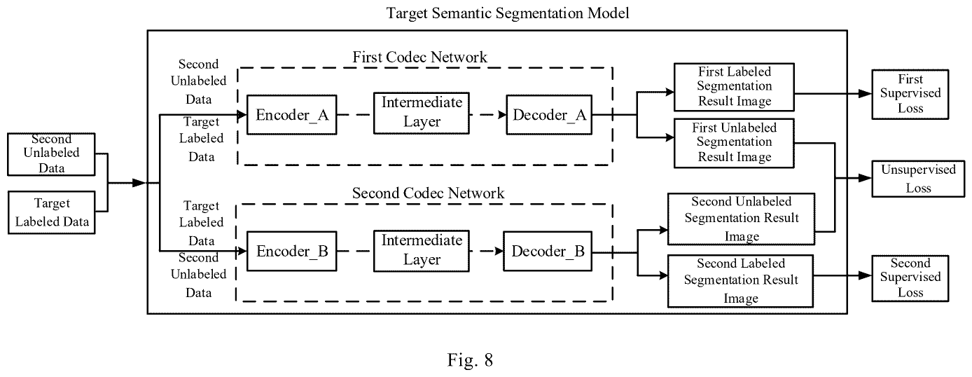

FIG. 8 is a schematic diagram of a process of generating a supervised loss and an unsupervised loss based on a target semantic segmentation model provided by the embodiments of the present disclosure. The above steps are described in detail below with reference to FIG. 8.

The target semantic segmentation model includes a first codec network and a second codec network. After the target labeled data is obtained, the target labeled data and the corresponding amount of pieces of second unlabeled data are separately input as inputs to the first codec network and the second codec network in the target semantic segmentation model. The first codec network and the second codec network independently process the respective input data, and then output the first labeled segmentation result image and the first unlabeled segmentation result image, and the second labeled segmentation result image and the second unlabeled segmentation result image, respectively. For the above-mentioned process, a reference may be made to the related description in the embodiment shown in FIG. 6, which will no longer be repeated here.

Subsequently, for the target labeled data, the corresponding supervised loss is obtained using a preset cross entropy loss function based on the first labeled segmentation result image and the corresponding first labeling information. As shown in the figure, the supervised loss includes a first supervised loss and a second supervised loss; the first supervised loss is generated from the first labeled segmentation result image output by the first codec network; and the second supervised loss is generated from the second labeled segmentation result image output by the second codec network.

Exemplarily, for the second unlabeled data, an additional consistency regularization loss function is utilized to guarantee that prediction results of two branches remain consistent based on the first unlabeled segmentation result image and the second unlabeled segmentation result image, i.e., the unsupervised loss of the first unlabeled segmentation result image and the second unlabeled segmentation result image is calculated. The implementation methods of the consistency regularization loss function and the cross entropy loss function are not described redundantly here.

Step S210: training the target semantic segmentation model based on the supervised loss and the unsupervised loss to obtain the optimized semantic segmentation model.

Exemplarily, the first codec network is provided with a first network parameter and the second codec network is provided with a second network parameter. The supervised loss includes a first supervised loss corresponding to the first codec network and a second supervised loss corresponding to the second codec network. Exemplarily, with reference to the schematic diagram of the target semantic segmentation model shown in FIG. 8, after the first supervised loss and the second supervised loss are obtained, weighting calculation is performed on three loss function values (i.e., the first supervised loss, the second supervised loss, and the unsupervised loss), e.g., an average value of the three loss function values is calculated, and then backward gradient propagation is performed to update the first network parameter in the first codec network and the second network parameter in the second codec network, thereby obtaining the optimized semantic segmentation model. Because the optimized semantic segmentation model has been trained with the target labeled data and the second unlabeled data as samples, the purpose of improving the model performance can be improved. Meanwhile, because the content in the target labeled data is a screened high-value content, training the target semantic segmentation model using the semi-supervised learning method provided in the present embodiment can further enhance the training effect such that the optimized semantic segmentation model obtained after training has better performance.

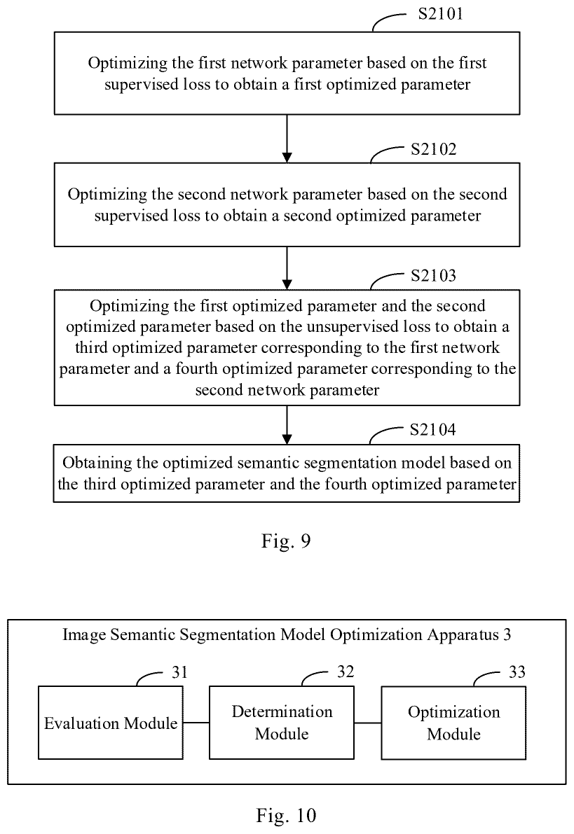

In an optional implementation, as shown in FIG. 9, step S210 includes the following implementation steps:
step S2101: optimizing the first network parameter based on the first supervised loss to obtain a first optimized parameter;
step S2102: optimizing the second network parameter based on the second supervised loss to obtain a second optimized parameter;
step S2103: optimizing the first optimized parameter and the second optimized parameter based on the unsupervised loss to obtain a third optimized parameter corresponding to the first network parameter and a fourth optimized parameter corresponding to the second network parameter; and
step S2104: obtaining the optimized semantic segmentation model based on the third optimized parameter and the fourth optimized parameter.

Exemplarily, in the steps of the present embodiment, after the first supervised loss and the second supervised loss are obtained, the first network parameter and the second network parameter in the target semantic segmentation model are firstly optimized with the first supervised loss and the second supervised loss, to independently improve the performance of the first codec network and the second codec network. On the basis that the first optimized parameter and the second optimized parameter have been obtained, the first optimized parameter and the second optimized parameter are further optimized based on the difference between the first codec network and the second codec network represented by the unsupervised loss, to obtain the third optimized parameter corresponding to the first network parameter and the fourth optimized parameter corresponding to the second network parameter. In the present embodiment, due to better performance and training effect with the labeled data, training is firstly performed using the target labeled data so that the model may be better guided to converge, and then the first codec network and the second codec network are further optimized based on the unsupervised loss so that the efficiency of model training and optimization may be improved, the training time may be shortened, and the quality of the optimized model may be improved.

Optionally, after the step S210 has been completely performed, step S201 may be performed again. The obtained optimized semantic segmentation model is used as a new target semantic segmentation model for further optimization until the obtained optimized semantic segmentation model reaches the preset performance or the training sample data has been used up. The process of cyclic optimization is the same as the (one) optimization process provided in the present embodiment, which will not be described redundantly.

In the present embodiment, the implementation of step S205 is the same as that of step S102 in the embodiment shown in FIG. 2 of the present disclosure, which will not be described redundantly one by one.

Corresponding to the image semantic segmentation model optimization method of the above-mentioned embodiments, FIG. 10 is a structural block diagram of an image semantic segmentation model optimization apparatus provided by the embodiments of the present disclosure. For ease of description, only the parts related to the embodiments of the present disclosure are illustrated. Referring to FIG. 10, the image semantic segmentation model optimization apparatus 3 includes:
an evaluation module 31, which is configured to acquire first unlabeled data, and evaluate the first unlabeled data based on a pre-trained target semantic segmentation model to obtain an evaluation value corresponding to the first unlabeled data, in which the evaluation value represents effectiveness of training the target semantic segmentation model with the first unlabeled data;
a determination module 32, which is configured to determine target unlabeled data according to the evaluation value corresponding to the first unlabeled data, and generate target labeled data corresponding to the target unlabeled data; and
an optimization module 33, which is configured to optimize the target semantic segmentation model based on the target labeled data to obtain an optimized semantic segmentation model.

In an embodiment of the present disclosure, the target semantic segmentation model includes a first codec network and a second codec network, and the evaluation module 31 is configured to: process the first unlabeled data based on the first codec network and the second codec network to obtain a first segmentation result image output by the first codec network and a second segmentation result image output by the second codec network, respectively; process the first segmentation result image and the second segmentation result image based on a preset sample evaluation model to obtain at least one feature value, in which the feature value represents an evaluation result of the first unlabeled data in a corresponding evaluation dimension; and perform weighting fusion on the at least one feature value to obtain the evaluation value corresponding to the first unlabeled data.

In an embodiment of the present disclosure, the feature value includes at least one selected from a group consisting of an information entropy evaluation value, a difficulty evaluation value, a diversity evaluation value, and a consistency evaluation value; the information entropy evaluation value is configured to represent an amount of information in the first unlabeled data; the difficulty evaluation value is configured to represent a prediction difficulty of the target semantic segmentation model for the first unlabeled data; the diversity evaluation value is configured to represent a prediction difference between the first segmentation result image and the second segmentation result image; and the consistency evaluation value is configured to represent a divergence distance between the first segmentation result image and the second segmentation result image.

In an embodiment of the present disclosure, when performing weighting fusion on the at least one feature value to obtain the evaluation value corresponding to the first unlabeled data, the evaluation module 31 is configured to: acquire respective weighting coefficients corresponding to respective feature values, in which the weighting coefficients are each determined based on a variation amount of a cross entropy loss corresponding to the target semantic segmentation model; and calculate a weighted sum of the respective feature values according to the respective weighting coefficients to obtain the evaluation value corresponding to the first unlabeled data.

In an embodiment of the present disclosure, the optimization module 33 is configured to: acquire second unlabeled data with a same amount as the target labeled data; and perform semi-supervised training on the image semantic segmentation model with the target labeled data and the second unlabeled data to obtain the optimized semantic segmentation model.

In an embodiment of the present disclosure, the target semantic segmentation model includes a first codec network and a second codec network, when performing semi-supervised training on the image semantic segmentation model with the target labeled data and the second unlabeled data to obtain the optimized semantic segmentation model, the optimization module 33 is configured to: input the target labeled data and the corresponding second unlabeled data to the first codec network to obtain a first labeled segmentation result image and a first unlabeled segmentation result image output by the first codec network; input the target labeled data and the corresponding second unlabeled data to the second codec network to obtain a second labeled segmentation result image and a second unlabeled segmentation result image output by the second codec network; obtain a supervised loss based on the first labeled segmentation result image and the second labeled segmentation result image; obtain an unsupervised loss based on the first unlabeled segmentation result image and the second unlabeled segmentation result image; and train the target semantic segmentation model based on the supervised loss and the unsupervised loss to obtain the optimized semantic segmentation model.

In an embodiment of the present disclosure, when obtaining the supervised loss based on the first labeled segmentation result image and the second labeled segmentation result image, the optimization module 33 is configured to calculate the first labeled segmentation result image and the second labeled segmentation result image based on a preset cross entropy loss function to obtain the supervised loss; and when obtaining the unsupervised loss based on the first unlabeled segmentation result image and the second unlabeled segmentation result image, the optimization module 33 is configured to calculate the first unlabeled segmentation result image and the second unlabeled segmentation result image based on a preset consistency regularization loss function to obtain the unsupervised loss.

In an embodiment of the present disclosure, the first codec network is provided with a first network parameter and the second codec network is provided with a second network parameter; the supervised loss includes a first supervised loss corresponding to the first codec network and a second supervised loss corresponding to the second codec network; and when training the target semantic segmentation model based on the supervised loss and the unsupervised loss to obtain the optimized semantic segmentation model, the optimization module 33 is configured to: optimize the first network parameter based on the first supervised loss to obtain a first optimized parameter; optimize the second network parameter based on the second supervised loss to obtain a second optimized parameter; optimize the first optimized parameter and the second optimized parameter based on the unsupervised loss to obtain a third optimized parameter corresponding to the first network parameter and a fourth optimized parameter corresponding to the second network parameter; and obtain the optimized semantic segmentation model based on the third optimized parameter and the fourth optimized parameter.

For example, the evaluation module 31, the determination module 32, and the optimization module 33 are connected in sequence. The image semantic segmentation model optimization apparatus 3 provided in the present embodiment can execute the technical solutions of the above-mentioned method embodiments, with similar principles and technical effects. Detailed descriptions of these aspects are omitted in the present embodiment.

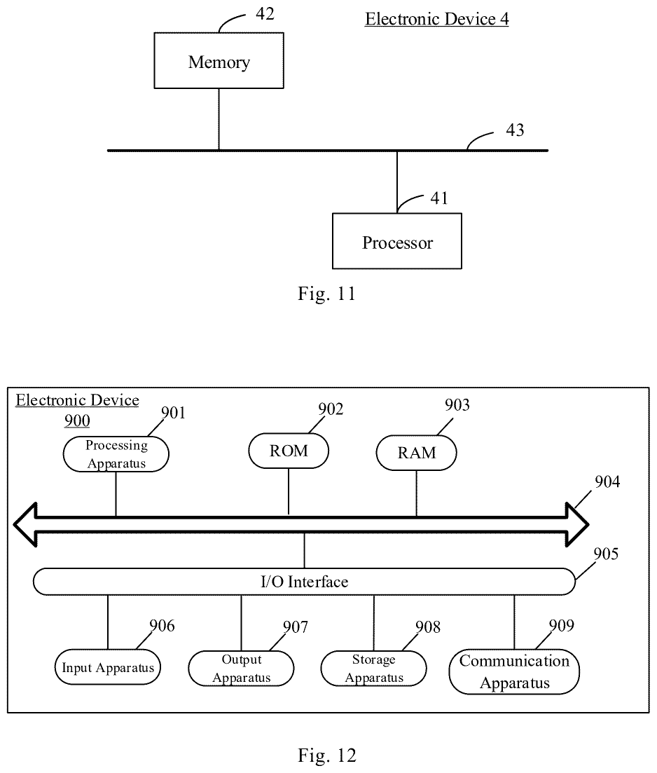

FIG. 11 is a schematic structural diagram of an electronic device provided by the embodiments of the present disclosure. As shown in FIG. 11, the electronic device 4 includes:
a processor 41 and a memory 42 in communication connection with the processor 41;
the memory 42 stores computer-executable instructions; and
the processor 41 is configured to execute the computer-executable instructions stored in the memory 42 to implement the image semantic segmentation model optimization method according to any embodiment shown in FIG. 2-FIG. 9.

Optionally, the processor 41 and the memory 42 are connected via a bus 43.

Relevant explanations may be understood by referring to the descriptions and effects corresponding to the steps in the embodiments associated with FIG. 2-FIG. 9. Detailed descriptions of these aspects are omitted here.

Referring to FIG. 12, FIG. 12 illustrates a schematic structural diagram of an electronic device 900 suitable for implementing the embodiments of the present disclosure. The electronic device 900 may be a terminal device or a server. The terminal device may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and a fixed terminal such as a digital TV, a desktop computer, or the like. The electronic device illustrated in FIG. 12 is merely an example, and should not pose any limitation to the functions and the range of use of the embodiments of the present disclosure.

As illustrated in FIG. 12, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected through a bus 904. An input/output (I/O) interface 905 is also connected to the bus 904.

Usually, the following apparatuses may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 12 illustrates the electronic device 900 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the methods illustrated in the above-mentioned embodiments.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, the first acquisition unit may also be described as a “unit for acquiring at least two Internet Protocol addresses.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, one or more embodiments of the present disclosure provide an image semantic segmentation model optimization method, which includes:
acquiring first unlabeled data, and evaluating the first unlabeled data based on a pre-trained target semantic segmentation model to obtain an evaluation value corresponding to the first unlabeled data, in which the evaluation value represents effectiveness of training the target semantic segmentation model with the first unlabeled data; determining target unlabeled data according to the evaluation value corresponding to the first unlabeled data, and generating target labeled data corresponding to the target unlabeled data; and optimizing the target semantic segmentation model based on the target labeled data to obtain an optimized semantic segmentation model.

According to one or more embodiments of the present disclosure, the target semantic segmentation model includes a first codec network and a second codec network, and the evaluating the first unlabeled data based on the pre-trained target semantic segmentation model to obtain the evaluation value corresponding to the first unlabeled data, includes: processing the first unlabeled data based on the first codec network and the second codec network to obtain a first segmentation result image output by the first codec network and a second segmentation result image output by the second codec network, respectively; processing the first segmentation result image and the second segmentation result image based on a preset sample evaluation model to obtain at least one feature value, in which the feature value represents an evaluation result of the first unlabeled data in a corresponding evaluation dimension; and performing weighting fusion on the at least one feature value to obtain the evaluation value corresponding to the first unlabeled data.

According to one or more embodiments of the present disclosure, the feature value includes at least one selected from a group consisting of an information entropy evaluation value, a difficulty evaluation value, a diversity evaluation value, and a consistency evaluation value; the information entropy evaluation value is configured to represent an amount of information in the first unlabeled data; the difficulty evaluation value is configured to represent a prediction difficulty of the target semantic segmentation model for the first unlabeled data; the diversity evaluation value is configured to represent a prediction difference between the first segmentation result image and the second segmentation result image; and the consistency evaluation value is configured to represent a divergence distance between the first segmentation result image and the second segmentation result image.

According to one or more embodiments of the present disclosure, the performing weighting fusion on the at least one feature value to obtain the evaluation value corresponding to the first unlabeled data, includes: acquiring respective weighting coefficients corresponding to respective feature values, in which the weighting coefficients are each determined based on a variation amount of a cross entropy loss corresponding to the target semantic segmentation model; and calculating a weighted sum of the respective feature values according to the respective weighting coefficients to obtain the evaluation value corresponding to the first unlabeled data.

According to one or more embodiments of the present disclosure, the optimizing the target semantic segmentation model based on the target labeled data to obtain the optimized semantic segmentation model, includes: acquiring second unlabeled data with a same amount as the target labeled data; and performing semi-supervised training on the image semantic segmentation model with the target labeled data and the second unlabeled data to obtain the optimized semantic segmentation model.

According to one or more embodiments of the present disclosure, the target semantic segmentation model includes a first codec network and a second codec network, and the performing semi-supervised training on the image semantic segmentation model with the target labeled data and the second unlabeled data to obtain the optimized semantic segmentation model, includes: inputting the target labeled data and the corresponding second unlabeled data to the first codec network to obtain a first labeled segmentation result image and a first unlabeled segmentation result image output by the first codec network; inputting the target labeled data and the corresponding second unlabeled data to the second codec network to obtain a second labeled segmentation result image and a second unlabeled segmentation result image output by the second codec network; obtaining a supervised loss based on the first labeled segmentation result image and the second labeled segmentation result image; obtaining an unsupervised loss based on the first unlabeled segmentation result image and the second unlabeled segmentation result image; and training the target semantic segmentation model based on the supervised loss and the unsupervised loss to obtain the optimized semantic segmentation model.

According to one or more embodiments of the present disclosure, the obtaining the supervised loss based on the first labeled segmentation result image and the second labeled segmentation result image includes: calculating the first labeled segmentation result image and the second labeled segmentation result image based on a preset cross entropy loss function to obtain the supervised loss; and the obtaining the unsupervised loss based on the first unlabeled segmentation result image and the second unlabeled segmentation result image includes: calculating the first unlabeled segmentation result image and the second unlabeled segmentation result image based on a preset consistency regularization loss function to obtain the unsupervised loss.

According to one or more embodiments of the present disclosure, the first codec network is provided with a first network parameter and the second codec network is provided with a second network parameter; the supervised loss includes a first supervised loss corresponding to the first codec network and a second supervised loss corresponding to the second codec network; and the training the target semantic segmentation model based on the supervised loss and the unsupervised loss to obtain the optimized semantic segmentation model includes: optimizing the first network parameter based on the first supervised loss to obtain a first optimized parameter; optimizing the second network parameter based on the second supervised loss to obtain a second optimized parameter; optimizing the first optimized parameter and the second optimized parameter based on the unsupervised loss to obtain a third optimized parameter corresponding to the first network parameter and a fourth optimized parameter corresponding to the second network parameter; and obtaining the optimized semantic segmentation model based on the third optimized parameter and the fourth optimized parameter.

In a second aspect, one or more embodiments of the present disclosure provide an image semantic segmentation model optimization apparatus, which includes:
an evaluation module, which is configured to acquire first unlabeled data, and evaluate the first unlabeled data based on a pre-trained target semantic segmentation model to obtain an evaluation value corresponding to the first unlabeled data, in which the evaluation value represents effectiveness of training the target semantic segmentation model with the first unlabeled data;
a determination module, which is configured to determine target unlabeled data according to the evaluation value corresponding to the first unlabeled data, and generate target labeled data corresponding to the target unlabeled data; and
an optimization module, which is configured to optimize the target semantic segmentation model based on the target labeled data to obtain an optimized semantic segmentation model.

According to one or more embodiments of the present disclosure, the target semantic segmentation model includes a first codec network and a second codec network, and the evaluation module is configured to: process the first unlabeled data based on the first codec network and the second codec network to obtain a first segmentation result image output by the first codec network and a second segmentation result image output by the second codec network, respectively; process the first segmentation result image and the second segmentation result image based on a preset sample evaluation model to obtain at least one feature value, in which the feature value represents an evaluation result of the first unlabeled data in a corresponding evaluation dimension; and perform weighting fusion on the at least one feature value to obtain the evaluation value corresponding to the first unlabeled data.

According to one or more embodiments of the present disclosure, the feature value includes at least one selected from a group consisting of an information entropy evaluation value, a difficulty evaluation value, a diversity evaluation value, and a consistency evaluation value; the information entropy evaluation value is configured to represent an amount of information in the first unlabeled data; the difficulty evaluation value is configured to represent a prediction difficulty of the target semantic segmentation model for the first unlabeled data; the diversity evaluation value is configured to represent a prediction difference between the first segmentation result image and the second segmentation result image; and the consistency evaluation value is configured to represent a divergence distance between the first segmentation result image and the second segmentation result image.

According to one or more embodiments of the present disclosure, when performing weighting fusion on the at least one feature value to obtain the evaluation value corresponding to the first unlabeled data, the evaluation module is configured to: acquire respective weighting coefficients corresponding to respective feature values, in which the weighting coefficients are each determined based on a variation amount of a cross entropy loss corresponding to the target semantic segmentation model; and calculate a weighted sum of the respective feature values according to the respective weighting coefficients to obtain the evaluation value corresponding to the first unlabeled data.

According to one or more embodiments of the present disclosure, the optimization module is configured to: acquire second unlabeled data with a same amount as the target labeled data; and perform semi-supervised training on the image semantic segmentation model with the target labeled data and the second unlabeled data to obtain the optimized semantic segmentation model.

According to one or more embodiments of the present disclosure, the target semantic segmentation model includes a first codec network and a second codec network, when performing semi-supervised training on the image semantic segmentation model with the target labeled data and the second unlabeled data to obtain the optimized semantic segmentation model, the optimization module is configured to: input the target labeled data and the corresponding second unlabeled data to the first codec network to obtain a first labeled segmentation result image and a first unlabeled segmentation result image output by the first codec network; input the target labeled data and the corresponding second unlabeled data to the second codec network to obtain a second labeled segmentation result image and a second unlabeled segmentation result image output by the second codec network; obtain a supervised loss based on the first labeled segmentation result image and the second labeled segmentation result image; obtain an unsupervised loss based on the first unlabeled segmentation result image and the second unlabeled segmentation result image; and train the target semantic segmentation model based on the supervised loss and the unsupervised loss to obtain the optimized semantic segmentation model.

According to one or more embodiments of the present disclosure, when obtaining the supervised loss based on the first labeled segmentation result image and the second labeled segmentation result image, the optimization module is configured to calculate the first labeled segmentation result image and the second labeled segmentation result image based on a preset cross entropy loss function to obtain the supervised loss; and when obtaining the unsupervised loss based on the first unlabeled segmentation result image and the second unlabeled segmentation result image, the optimization module is configured to calculate the first unlabeled segmentation result image and the second unlabeled segmentation result image based on a preset consistency regularization loss function to obtain the unsupervised loss.

According to one or more embodiments of the present disclosure, the first codec network is provided with a first network parameter and the second codec network is provided with a second network parameter; the supervised loss includes a first supervised loss corresponding to the first codec network and a second supervised loss corresponding to the second codec network; and when training the target semantic segmentation model based on the supervised loss and the unsupervised loss to obtain the optimized semantic segmentation model, the optimization module is configured to: optimize the first network parameter based on the first supervised loss to obtain a first optimized parameter; optimize the second network parameter based on the second supervised loss to obtain a second optimized parameter; optimize the first optimized parameter and the second optimized parameter based on the unsupervised loss to obtain a third optimized parameter corresponding to the first network parameter and a fourth optimized parameter corresponding to the second network parameter; and obtain the optimized semantic segmentation model based on the third optimized parameter and the fourth optimized parameter.

In a third aspect, one or more embodiments of the present disclosure provide an electronic device, which includes a processor and a memory in communication connection with the processor;
the memory stores computer-executable instructions; and
the processor is configured to execute the computer-executable instructions stored in the memory to implement the image semantic segmentation model optimization method according to the first aspect or any embodiment in the first aspect.

In a fourth aspect, one or more embodiments of the present disclosure provide a computer-readable storage medium, which stores computer-executable instructions, and a processor, when executing the computer-executable instructions, implements the image semantic segmentation model optimization method according to the first aspect or any embodiment in the first aspect.

In a fifth aspect, one or more embodiments of the present disclosure provide a computer program product, which includes a computer program, and the computer program, when executed by a processor, implements the image semantic segmentation model optimization method according to the first aspect or any embodiment in the first aspect.

In a sixth aspect, one or more embodiments of the present disclosure provide a computer program, which is configured to implement the image semantic segmentation model optimization method according to the first aspect or any embodiment in the first aspect.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. An image semantic segmentation model optimization method, comprising:
acquiring first unlabeled data, and evaluating the first unlabeled data based on a pre-trained target semantic segmentation model to obtain an evaluation value corresponding to the first unlabeled data, wherein the evaluation value represents effectiveness of training the target semantic segmentation model with the first unlabeled data;
determining target unlabeled data according to the evaluation value corresponding to the first unlabeled data, and generating target labeled data corresponding to the target unlabeled data; and
optimizing the target semantic segmentation model based on the target labeled data to obtain an optimized semantic segmentation model.

2. The method according to claim 1, wherein the target semantic segmentation model comprises a first codec network and a second codec network, and the evaluating the first unlabeled data based on the pre-trained target semantic segmentation model to obtain the evaluation value corresponding to the first unlabeled data, comprises:
processing the first unlabeled data based on the first codec network and the second codec network to obtain a first segmentation result image output by the first codec network and a second segmentation result image output by the second codec network, respectively;
processing the first segmentation result image and the second segmentation result image based on a preset sample evaluation model to obtain at least one feature value, wherein the feature value represents an evaluation result of the first unlabeled data in a corresponding evaluation dimension; and
performing weighting fusion on the at least one feature value to obtain the evaluation value corresponding to the first unlabeled data.

3. The method according to claim 2, wherein the feature value comprises at least one selected from a group consisting of an information entropy evaluation value, a difficulty evaluation value, a diversity evaluation value, and a consistency evaluation value;
the information entropy evaluation value is configured to represent an amount of information in the first unlabeled data;
the difficulty evaluation value is configured to represent a prediction difficulty of the target semantic segmentation model for the first unlabeled data;
the diversity evaluation value is configured to represent a prediction difference between the first segmentation result image and the second segmentation result image; and
the consistency evaluation value is configured to represent a divergence distance between the first segmentation result image and the second segmentation result image.

4. The method according to claim 2, wherein the performing weighting fusion on the at least one feature value to obtain the evaluation value corresponding to the first unlabeled data, comprises:
acquiring respective weighting coefficients corresponding to respective feature values, wherein the weighting coefficients are each determined based on a variation amount of a cross entropy loss corresponding to the target semantic segmentation model; and
calculating a weighted sum of the respective feature values according to the respective weighting coefficients to obtain the evaluation value corresponding to the first unlabeled data.

5. The method according to claim 1, wherein the optimizing the target semantic segmentation model based on the target labeled data to obtain the optimized semantic segmentation model, comprises:
acquiring second unlabeled data with a same amount as the target labeled data; and
performing semi-supervised training on the image semantic segmentation model with the target labeled data and the second unlabeled data to obtain the optimized semantic segmentation model.

6. The method according to claim 5, wherein the target semantic segmentation model comprises a first codec network and a second codec network, and the performing semi-supervised training on the image semantic segmentation model with the target labeled data and the second unlabeled data to obtain the optimized semantic segmentation model, comprises:
inputting the target labeled data and the corresponding second unlabeled data to the first codec network to obtain a first labeled segmentation result image and a first unlabeled segmentation result image output by the first codec network;
inputting the target labeled data and the corresponding second unlabeled data to the second codec network to obtain a second labeled segmentation result image and a second unlabeled segmentation result image output by the second codec network;
obtaining a supervised loss based on the first labeled segmentation result image and the second labeled segmentation result image;
obtaining an unsupervised loss based on the first unlabeled segmentation result image and the second unlabeled segmentation result image; and
training the target semantic segmentation model based on the supervised loss and the unsupervised loss to obtain the optimized semantic segmentation model.

7. The method according to claim 6, wherein the obtaining the supervised loss based on the first labeled segmentation result image and the second labeled segmentation result image comprises:
calculating the first labeled segmentation result image and the second labeled segmentation result image based on a preset cross entropy loss function to obtain the supervised loss; and
the obtaining the unsupervised loss based on the first unlabeled segmentation result image and the second unlabeled segmentation result image comprises:
calculating the first unlabeled segmentation result image and the second unlabeled segmentation result image based on a preset consistency regularization loss function to obtain the unsupervised loss.

8. The method according to claim 6, wherein the first codec network is provided with a first network parameter and the second codec network is provided with a second network parameter; the supervised loss comprises a first supervised loss corresponding to the first codec network and a second supervised loss corresponding to the second codec network; and the training the target semantic segmentation model based on the supervised loss and the unsupervised loss to obtain the optimized semantic segmentation model comprises:
optimizing the first network parameter based on the first supervised loss to obtain a first optimized parameter;
optimizing the second network parameter based on the second supervised loss to obtain a second optimized parameter;
optimizing the first optimized parameter and the second optimized parameter based on the unsupervised loss to obtain a third optimized parameter corresponding to the first network parameter and a fourth optimized parameter corresponding to the second network parameter; and
obtaining the optimized semantic segmentation model based on the third optimized parameter and the fourth optimized parameter.

9. (canceled)

10. An electronic device, comprising a processor and a memory in communication connection with the processor,
wherein the memory stores computer-executable instructions; and
the processor is configured to execute the computer-executable instructions stored in the memory to implement an image semantic segmentation model optimization method, which comprises:
acquiring first unlabeled data, and evaluating the first unlabeled data based on a pre-trained target semantic segmentation model to obtain an evaluation value corresponding to the first unlabeled data, wherein the evaluation value represents effectiveness of training the target semantic segmentation model with the first unlabeled data:
determining target unlabeled data according to the evaluation value corresponding to the first unlabeled data, and generating target labeled data corresponding to the target unlabeled data; and
optimizing the target semantic segmentation model based on the target labeled data to obtain an optimized semantic segmentation model.

11. A non-transitory computer-readable storage medium, storing computer-executable instructions, wherein a processor, when executing the computer-executable instructions, implements an image semantic segmentation model optimization method, which comprises:
acquiring first unlabeled data, and evaluating the first unlabeled data based on a pre-trained target semantic segmentation model to obtain an evaluation value corresponding to the first unlabeled data, wherein the evaluation value represents effectiveness of training the target semantic segmentation model with the first unlabeled data;
determining target unlabeled data according to the evaluation value corresponding to the first unlabeled data, and generating target labeled data corresponding to the target unlabeled data; and
optimizing the target semantic segmentation model based on the target labeled data to obtain an optimized semantic segmentation model.

12-13. (canceled)

14. The method according to claim 3, wherein the performing weighting fusion on the at least one feature value to obtain the evaluation value corresponding to the first unlabeled data, comprises:
acquiring respective weighting coefficients corresponding to respective feature values, wherein the weighting coefficients are each determined based on a variation amount of a cross entropy loss corresponding to the target semantic segmentation model; and
calculating a weighted sum of the respective feature values according to the respective weighting coefficients to obtain the evaluation value corresponding to the first unlabeled data.

15. The method according to claim 2, wherein the optimizing the target semantic segmentation model based on the target labeled data to obtain the optimized semantic segmentation model, comprises:
acquiring second unlabeled data with a same amount as the target labeled data; and
performing semi-supervised training on the image semantic segmentation model with the target labeled data and the second unlabeled data to obtain the optimized semantic segmentation model.

16. The method according to claim 3, wherein the optimizing the target semantic segmentation model based on the target labeled data to obtain the optimized semantic segmentation model, comprises:
acquiring second unlabeled data with a same amount as the target labeled data; and
performing semi-supervised training on the image semantic segmentation model with the target labeled data and the second unlabeled data to obtain the optimized semantic segmentation model.

17. The method according to claim 4, wherein the optimizing the target semantic segmentation model based on the target labeled data to obtain the optimized semantic segmentation model, comprises:
acquiring second unlabeled data with a same amount as the target labeled data; and
performing semi-supervised training on the image semantic segmentation model with the target labeled data and the second unlabeled data to obtain the optimized semantic segmentation model.

18. The method according to claim 7, wherein the first codec network is provided with a first network parameter and the second codec network is provided with a second network parameter; the supervised loss comprises a first supervised loss corresponding to the first codec network and a second supervised loss corresponding to the second codec network; and the training the target semantic segmentation model based on the supervised loss and the unsupervised loss to obtain the optimized semantic segmentation model comprises:
optimizing the first network parameter based on the first supervised loss to obtain a first optimized parameter;
optimizing the second network parameter based on the second supervised loss to obtain a second optimized parameter;
optimizing the first optimized parameter and the second optimized parameter based on the unsupervised loss to obtain a third optimized parameter corresponding to the first network parameter and a fourth optimized parameter corresponding to the second network parameter; and
obtaining the optimized semantic segmentation model based on the third optimized parameter and the fourth optimized parameter.

19. The electronic device according to claim 10, wherein the target semantic segmentation model comprises a first codec network and a second codec network, and the evaluating the first unlabeled data based on the pre-trained target semantic segmentation model to obtain the evaluation value corresponding to the first unlabeled data, comprises:
processing the first unlabeled data based on the first codec network and the second codec network to obtain a first segmentation result image output by the first codec network and a second segmentation result image output by the second codec network, respectively;
processing the first segmentation result image and the second segmentation result image based on a preset sample evaluation model to obtain at least one feature value, wherein the feature value represents an evaluation result of the first unlabeled data in a corresponding evaluation dimension; and
performing weighting fusion on the at least one feature value to obtain the evaluation value corresponding to the first unlabeled data.

20. The electronic device according to claim 19, wherein the feature value comprises at least one selected from a group consisting of an information entropy evaluation value, a difficulty evaluation value, a diversity evaluation value, and a consistency evaluation value;
the information entropy evaluation value is configured to represent an amount of information in the first unlabeled data;
the difficulty evaluation value is configured to represent a prediction difficulty of the target semantic segmentation model for the first unlabeled data;
the diversity evaluation value is configured to represent a prediction difference between the first segmentation result image and the second segmentation result image; and
the consistency evaluation value is configured to represent a divergence distance between the first segmentation result image and the second segmentation result image.

21. The electronic device according to claim 19, wherein the performing weighting fusion on the at least one feature value to obtain the evaluation value corresponding to the first unlabeled data, comprises:
acquiring respective weighting coefficients corresponding to respective feature values, wherein the weighting coefficients are each determined based on a variation amount of a cross entropy loss corresponding to the target semantic segmentation model; and
calculating a weighted sum of the respective feature values according to the respective weighting coefficients to obtain the evaluation value corresponding to the first unlabeled data.

22. The electronic device according to claim 10, wherein the optimizing the target semantic segmentation model based on the target labeled data to obtain the optimized semantic segmentation model, comprises:
acquiring second unlabeled data with a same amount as the target labeled data; and
performing semi-supervised training on the image semantic segmentation model with the target labeled data and the second unlabeled data to obtain the optimized semantic segmentation model.

23. The electronic device according to claim 22, wherein the target semantic segmentation model comprises a first codec network and a second codec network, and the performing semi-supervised training on the image semantic segmentation model with the target labeled data and the second unlabeled data to obtain the optimized semantic segmentation model, comprises:
inputting the target labeled data and the corresponding second unlabeled data to the first codec network to obtain a first labeled segmentation result image and a first unlabeled segmentation result image output by the first codec network;
inputting the target labeled data and the corresponding second unlabeled data to the second codec network to obtain a second labeled segmentation result image and a second unlabeled segmentation result image output by the second codec network;
obtaining a supervised loss based on the first labeled segmentation result image and the second labeled segmentation result image;
obtaining an unsupervised loss based on the first unlabeled segmentation result image and the second unlabeled segmentation result image; and
training the target semantic segmentation model based on the supervised loss and the unsupervised loss to obtain the optimized semantic segmentation model.
